(19) United States
(12) Patent Application Publication
(10) Pub. No.: US 2007/0185622 A1
(43) Pub. Date: Aug. 9, 2007

(54) Method for Controlling a Process

(75) Inventor: Peter Wanke, Frankfurt (DE)

Correspondence Address: Craig Hallacher;Continental Teves, One Continental Drive, Auburn Hills, MI, 48326, US

(73) Assignee: Continental Teves AG & Co. OHG, Auburn Hills, MI (US)

(21) Appl. No.: 10/558,449

(22) PCT Filed: May 26, 2004
(86) PCT No.: PCT/EP04/50927

§ 371 Date: Oct. 5, 2006

(30) Foreign Application Priority Data
May 26, 2003 (DE) 10324131.0

(51) Int. Cl. G06F 17/00

(52) U.S. Cl. 701/1

(57) ABSTRACT

Disclosed is a method for controlling a process according to which an actuation parameter is produced depending on a control deviation that is determined by comparing a nominal value with an actual value of a control variable. The method is characterized in that the actual value of the control variable is determined based on a first process model and a need for control (10) is additionally verified by determining control requirements (20, 30, 40) by way of values of the control variable, which are identified by additional process models and associated with each other by means of logical operations.

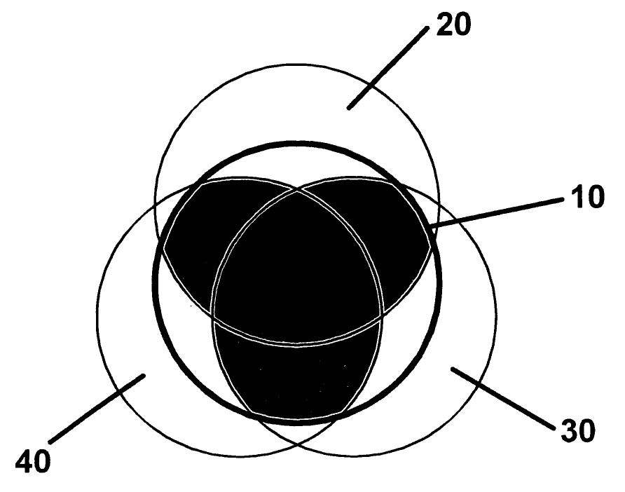

### BACKGROUND OF THE INVENTION

The present invention relates to a method for controlling a process according to which an actuation parameter is produced depending on a control deviation that is determined by comparing a nominal value with an actual value of a control variable.

The method is especially suitable for implementing driving stability control for a vehicle.

The term ‘driving stability control’ integrates several principles for influencing the driving performance of a vehicle by predefinable pressures in or brake forces at individual wheel brakes, intervention into the engine management, superposition of an additional steering angle on a steering angle adjusted by a driver, and intervention into absorbers at the wheels or stabilizers at the axles. Embodiments of driving dynamics control imply in particular brake slip control operations (ABS) which prevent individual wheels from locking during a braking operation, anti-slip control operations or traction control operations (TCS) preventing the spinning of the driving wheels, electronic brake force boosting (EBD) for controlling the relationship between the brake force on the front and rear axles, roll-over prevention operations (ARP) to prevent roll-over of a vehicle about its longitudinal axis, and yaw torque control (ESP) for stabilizing the vehicle.

A driving stability controller which, in addition, includes a limitation of a reference yaw rate responsive to the coefficient of friction is e.g. disclosed in German published application DE 195 15 059 which is herein referred to in its full scope. The illustrated control circuit relates to a motor vehicle with four wheels that is equipped with a hydraulic, electro-hydraulic or electro-mechanical brake system. The driver builds up brake pressure by means of a pedal-operated master cylinder in hydraulic brake systems, while the electro-hydraulic and electro-mechanical brake systems develop a brake force in response to a sensed braking request of a driver. Reference will be made to a hydraulic brake system in the following.

To detect driving-dynamics conditions, the controller is provided with a rotational speed sensor for each wheel, a yaw rate sensor, a lateral acceleration sensor, and a pressure sensor for sensing the brake pressure produced b means of a brake pedal.

A fallback mode for the controller is typically realized when using a sensor cluster composed of several sensors so that in case one part of the sensor system fails only that component of the control will be respectively disabled which requires measured values from the failed sensors as input quantities.

A sensor cluster for implementing driving dynamics control is e.g. described also in German published patent application DE 198 11 547.

The function of the sensors can be monitored by plausibility tests based on analytic redundancies. Usually several sensor values of equal physical quantities are determined by way of signals and compared with each other.

Likewise arrangements to protect sensors are known from the state of the art. Thus, German published patent application DE 199 21 692 A1, which shall be included herein also in its full scope, discloses an arrangement for protecting electronic function units against disturbances, wherein the function units are classified into components of different sensitivity in relation to spurious signals. Different types of shields are provided for these components, and at least two of the shields add to become a shield having a higher efficiency than the individual shields.

It is, thus, possible to detect the occurrence of defects in the sensor system, or to virtually avoid them, respectively. The fallback modes further prevent that an erroneous control operation is performed where safety-critical values of actuation parameters could develop.

It is, nevertheless, desirable in many cases to maintain the control function upon failure of a sensor. This applies in particular for driving stability control operations which serve to enhance the safety in a vehicle.

Even after a successful introduction of a technical control system on the market there is often the desire to economize sensors. The system functionality should, however, be safeguarded in an appropriate fashion even after the omission of sensors.

### SUMMARY OF THE INVENTION

In view of the above, an object of the invention is to be able to control a process reliably and safely even if there is no signal of a sensor that represents the value of a control variable.

According to the invention, this object is achieved by a method of controlling process that includes determining a control deviation, determining a need for control, determining a control variable, and verifying the need for control based on the control variable.

The invention provides that a method for controlling a process, according to which a need for control is determined depending on a control deviation determined by comparing a nominal value with an actual value of a control variable, is implemented in such a fashion that the actual value of the control parameter is determined by way of a first process model and the need for control is additionally verified by determining control requirements based on values of the control variable, which values are defined by way of additional process models and linked to each other by logical operations.

Thus, the invention provides a method that permits preserving a control function even upon failure or omission of a sensor signal. The special advantage involved with the method is that erroneous control interventions are avoided which can be caused by malfunctions of the remaining sensors.

It is the basic idea of the invention that a signal representative of the actual value of the control variable is reproduced in a suitable model and the need for control is verified by way of additional models which, admittedly, are less appropriate for the quantitative reproduction of the value of the control variable than the first model, each one of which, however, is less susceptible to errors in the measured variables.

In a preferred embodiment of the method of the invention, the additional process models are therefore produced with different subsets of a multitude of measured variables. It is thereby ensured that the additional process models are constructed irrespective of at least one measured variable and, hence, each of the partial models remains unaffected by at least one error of measurement.

In this arrangement, the values of the control variable are preferably determined by way of at least two additional process models. Thus, there is an analytic redundancy constituted of at least two values for the value of the control variable, which is taken into account for a well-founded assessment of the need for control.

As they are generally produced with fewer variables than the first process model, the additional process models are less complex than the first model and, hence, permit a less precise reproduction of the measuring signal of the control variable than the first model. However, the invention offers the possibility of verifying the necessity of a control intervention by way of the additional models.

In a favorable embodiment of the method, a need for control is detected only if there is a need for control for the majority of the additional process models.

This control intervention can then take place in such a manner that the value of an actuation parameter is determined alone from the control deviation between the actual value of the control variable established by way of the first process model and the nominal value. A control intervention of this type is referred to as an unlimited control intervention in the following.

To minimize the consequences of a possibly incorrect assessment of a need for control, it is favorably arranged for that an unlimited control intervention is only performed when there is a need for control for all additional process models.

If there is a need for control for the majority, yet not for all, of the process models, it is arranged for in a preferred embodiment of the method of the invention that a control intervention has a duration that is reduced in comparison with an unlimited intervention or has an intensity that is reduced in comparison with an unlimited intervention. Control interventions of this type are referred to as limited control interventions in the following.

In addition, many control systems include the possibility of determining the situation of a total process by way of individual measured values or by way of the time variation of measuring signals. These control system are hence enabled to judge the quality of individual measuring signals in response to a situation. Further, many control systems include a configuration in which a control of actuators influences the measuring signals.

As the actuators are controlled by the control system itself, it is possible to have the quality of the measuring signals judged by the control system also in this case. This means that a situation-responsive judgment of the reliability of the different process models can be performed in the described control systems.

When a defined process model proves especially reliable in a situation, it is favorable that the control of the process by way of this model is not only performed qualitatively corresponding to the previously described embodiments of the method of the invention but also quantitatively depending on the value of the control variable determined in this model.

In another preferred embodiment of the method, the value of the actuation parameter which is produced by the controller in a case of need for control is therefore modified depending on at least one value of the control variable that is determined by way of the additional process models.

The method of the invention includes the advantage that it can be implemented without basic modifications both in a stand-alone system and within an emergency running function of an existing system.

The employment of the method at issue renders it possible to realize an emergency running logic which is largely based on the functions of the standard system.

### BRIEF DESCRIPTION OF THE DRAWING

Further advantages and suitable improvements of the invention can be taken from the following embodiments of the invention illustrated by way of the only FIGURE.

The FIGURE shows a sketch depicting the principle of the invention of the combined consideration of standard logic and partial models.

### DETAILED DESCRIPTION OF THE DRAWING

The invention provides a favorable method for controlling a process. It discloses that the actual value of a control variable is determined in a model and verified by means of a multiple process model because analytic redundancies for the value of the control variable are produced from process measured variables and process command variables, and the actual value is assessed by way of an evaluation and logical operation of the redundancies.

The method is especially appropriate to perform a driving stability control operation for a vehicle. As an example for an embodiment of the method of the invention, a driving dynamics control operation will be described in the following which is performed without the signals of a yaw rate sensor. However, it is also possible to apply the method without any basic modifications in the event of omission of other sensors.

An application in optional control systems which allow producing corresponding substitute signals is also possible without any problems. Analytic redundancies must be determined in the respective systems for this purpose, which exist for the process to be controlled based on different process models or based on different partial models, and the individual models must be evaluated with regard to their reliability. After the evaluation of the models, a model must then be found in which the actual value of the control variable on which the control interventions found is determined, and those models must be found which allow verifying the need for control by logical operations of the control requirements established in these models.

On the one hand, the implementation of the method of the invention within the limits of driving dynamics control for a vehicle can be realized as a stand-alone solution, as will be described in the following. It is hence possible to carry out yaw torque control in the absence of a yaw rate sensor.

On the other hand, the control can also be integrated as an emergency running function into an existing system for driving dynamics control, as has e.g. been described in the published patent application DE 195 15 059 A1.

The driving dynamics control without a yaw rate sensor which can be performed by way of the method of the invention employs functions and sensors which are available in prior art control systems for implementing an Electronic Stability Program (ESP). These functions and sensors can be seen in published patent application DE 195 15 059 A1. Reference is being made within the full scope of this publication.

Besides, a sensor cluster connection can be employed according to published patent application DE 199 21 692 and published patent application DE 198 11 547.

The basic input variables of a system of this type being measured by corresponding sensors are the steering angle δ, the yaw rate \dot{ψ}, the lateral acceleration a_{LAT} and the wheel speeds v_{FL}, v_{FR}, v_{RL}, v_{RR}. Considering the wheel speeds, v_{FL} refers to the speed of the left front wheel, v_{FR} refers to the speed of the right front wheel, v_{RL} designates the speed of the left rear wheel and v_{RR} the speed of the right rear wheel.

In a preferred embodiment of the ESP control, a control deviation is determined between the measured actual value of the yaw rate \dot{ψ} and a nominal value that is established based on the measured values of the steering angle δ, of the wheel speeds v_{FL}, v_{FR}, v_{RL} and v_{RR} as well based on vehicle parameters p in a reference model of the vehicle. From this control deviation, a brake pressure for each wheel and an intervention into the engine management are determined, which cause a compensating yaw torque that adapts the yaw rate \dot{ψ} of the vehicle to its nominal value.

Depending on the prevailing coefficient of friction, a reference yaw rate is further determined, additionally representing a threshold value for the physically possible yaw rates. The control also prevents that this threshold value is exceeded.

In addition, an ESP system generally comprises sensors which sense the current conditions of the actuators of the system. Thus, typical ESP systems comprise, for example, a pressure sensor for sensing a brake pressure in the master brake cylinder if the vehicle is equipped with a hydraulic brake system. Other ESP systems are additionally equipped with pressure sensors for sensing the brake pressures in the individual wheel brakes.

The embodiment of the invention that will be described hereinbelow is based on an omission of the yaw rate signal.

The yaw rate \dot{ψ} is reproduced corresponding to the method of the invention in a process model by the variables whose values are measured by the remaining sensors.

In this model formed by way of the variables δ, a_{LAT}, v_{FL}, v_{FR}, v_{RL}, v_{RR} and p, the actual value \dot{ψ}_{EST} of the yaw rate \dot{ψ} is the result of the measured values of the prevailing sensors by a correlation of the form \dot{ψ}_{EST}=\dot{ψ}_{EST} (δ, a_{LAT}, v_{FL}, v_{FR}, v_{RL}, v_{RR}; p) and is compared with a nominal value which is also determined by way of the values of these variables.

In front-wheel driven vehicles, the substitute signal REST can be determined from the relation
\dot{ψ}_{EST}=c₁(v_{RR}−v_{RL})−c₂·a_{LAT}·v_{REF}
where c₁ and c₂ are vehicle parameters and v_{REF} designates the reference speed of the vehicle being produced from the variables v_{FL}, v_{FR}, v_{RL} and v_{RR}.

Accordingly,
\dot{ψ}_{EST}=c₁(v_{FR}−v_{FL})−c₂·a_{LAT}·v_{REF}
applies for rear-wheel driven vehicles. The noise of the signal \dot{ψ}_{EST} can be reduced by appropriate signal processing. Likewise, the phase variations of the individual signals are adapted to one another by an appropriate filtering operation. As this occurs, the filtering operation should be executed in such a fashion that the phase variation of the substitute signal \dot{ψ}_{EST} corresponds to the actual phase variation of the yaw rate \dot{ψ} to the best possible extent. In the absence of a yaw rate sensor, this can be done by way of data of a reference model.

When the substitute signal \dot{ψ}_{EST} determined this way in the model is introduced as a substitute of a measured yaw rate signal \dot{ψ} into a means for implementing an ESP control algorithm, driving dynamics control without a yaw rate sensor can be performed in a simple fashion.

However, a high degree of interference liability of the control system must be expected, which becomes apparent from a frequent occurrence of undesirable control interventions. To correct measuring signals affected by interference effects and to avoid erroneous control interventions, it is possible to take the measures being described in the following.

To the extent possible, additional status information is taken into account in order to detect faults of the variables used to produce the signal \dot{ψ}_{EST}. When it is thereby rendered possible to determine the time variation and the extent of a fault, its influence on the signal \dot{ψ}_{EST} can be compensated directly.

If, for example, the signal representative of the value of the lateral acceleration a_{LAT} is distorted due to a gradient of the roadway by a known amount Δa_{LAT,BANK}, the relation
\dot{ψ}_{EST}=c₁(v_{FR}−v_{FL})−c₂·(a_{LAT}−Δa_{LAT,BANK})·v_{REF}
allows determining a corrected signal \dot{ψ}_{EST}. A lateral inclination of the roadway can then be detected because the wheel speeds, the lateral acceleration, or the steering angle can be determined at the same time by means of different measuring systems and/or models based on different physical methods, and their different variables which are caused due to errors in the inclined curves are used to detect he laterally inclined curve.

Similarly, it is also possible to compensate variations of the vehicle parameters c₁ and c₂, which are e.g. induced by a modified loading of the vehicle, provided that the deviations could be identified by an appropriate algorithm.

Further, there is a frequent occurrence of faults which are caused by the control system itself or can be affected by it. Generally, the time variation rather than its extent is known for these faults.

When e.g. one or more of the wheel brakes of the vehicle are actuated, the values for the wheel speeds v_{FL}, v_{FR}, v_{RL} and v_{RR} measured by wheel speed sensors do not correspond to the actual vehicle performance.

A like fault of the signals of the wheel speed sensors can be actively eliminated in that pressures in the brakes of the rear wheels are reduced, the wheel speed sensors of which deliver input signals for the control system. Of course the pressure reduction at the rear wheels cannot be requested constantly in order to improve the results of measurement, because a major loss in the brake output of the vehicle brake system goes along with the pressure reduction.

Therefore, it is initially determined by way of measuring signals which are not affected by any known fault whether a situation prevails in which the actual value of the control variable, which is calculated in a defined process model by way of the known spurious signal, is required for a possible control intervention.

This means, when a need for control by the ESP system results during braking of a vehicle based on a value for the yaw rate \dot{ψ} that is determined in a process model produced with the steering angle δ and the lateral acceleration a_{LAT}, an active pressure reduction will be performed on the rear wheels.

The actual need for control and the values of the actuation parameter are then determined based on model \dot{ψ}_{EST}(a_{LAT}, v_{RL}, v_{RR}; p) comprising the wheel speeds v_{RL} and v_{RR} for a front-wheel driven vehicle as soon as it can be assumed due to an assessment of additional sensor signals or model calculations that the signals of the wheel speed sensors are no longer disturbed. This may e.g. be detected depending on a model for determining the pressures in the wheel brakes of the rear wheels.

The control takes place after the pressure reduction exactly as in the undisturbed case which herein corresponds to the unbraked case.

Advantageously, an insignificant pressure increase on the front axle is achieved in a case of pressure reduction on the rear axle, frequently even without a conscious reaction of the driver, that means at a constant pedal force, so that in general no deceleration losses will be detected in a case of partial braking.

If, although the time variation of a fault is known, it is impossible or undesirable to take active influence under technical aspects, as has been described in the above, there is now as before the possibility of maintaining the control function by a temporary employment of a second substitute signal.

In case that all the available measuring signals have already been taken into consideration in the first model, the model used to determine the second substitute signal can only be a partial model.

Thus, the illustrated case corresponds to the embodiment of the method of the invention, wherein the value of the actuation parameter is modified situation-responsively depending on at least one value determined by way of the additional process model. In this event, even the extreme case is realized in which the value of the actuation parameter is determined exclusively depending on the value established by way of an additional process.

If it is desired e.g. in a front-wheel driven vehicle to perform an active pressure increase on the rear axle during an understeering situation in order to stabilize the vehicle, which pressure increase represents a disturbance for the signals of the wheel speed sensors, the form

$${\dot{ψ}}_{EST , TEMP} = \frac{{a}_{LAT}}{{v}_{REF}} - Δ {\dot{ψ}}_{EST}$$

can determine a temporary substitute signal \dot{ψ}_{EST,TEMP} for the time of the brake intervention which can be used as a signal representative of the actual value of the control variable for the duration of the brake intervention at the rear wheels. The actuation parameters are produced by the ESP control from the control deviation between the value \dot{ψ}_{EST,TEMP} and the nominal value of the yaw rate \dot{ψ}.

The variable Δ\dot{ψ}_{EST} in the previous form represents the difference between the values of the signal \dot{ψ}_{EST} and of the yaw rate signal a_{LAT}/v_{REF} at the point of time of the change-over between the two signals and is taken up in the form in order to avoid abrupt signal changes during change-over.

The temporary substitute signal \dot{ψ}_{EST,TEMP} is produced by way of a process model which generally does not reproduce the vehicle performance with a sufficient rate of accuracy.

Therefore, appropriate situation detection is needed to detect whether the substitute signal \dot{ψ}_{EST,TEMP} can be used or which of the available substitute signals allows determining reliable values for the control variable. To restrict negative consequences of the reduced accuracy of the temporary substitute signal \dot{ψ}_{EST,TEMP}, it can prove favorable to limit the duration of a control intervention on the basis of the temporary substitute signal in order to be able to use the more accurate signal \dot{ψ}_{EST} again after a defined period of time.

In addition, faults of the signals are caused by deficiencies of the sensors, among which are e.g. noise and signal errors, or which are caused by unpredictable changes in the ambient conditions. Uneven road conditions can be named as an example for such a change.

The influence of these faults on the value of the yaw rate determined in a model cannot be compensated by the methods described before, if neither the magnitude of these disturbing effects, nor their time variation is known. Consequently, they are genuine disturbances in the sense of the control technique, and protection against any control interventions caused by these disturbances can be achieved by means of the method of the invention.

This fact allows executing yaw rate control without a yaw rate sensor in a reliable and safe manner.

Driving dynamics control without a yaw rate sensor for a front-wheel driven vehicle will be assumed for the following embodiments. The remaining sensor system shall comprise the sensors described hereinabove, while, however, a separate illustration of the front-wheel speeds v_{FL} and v_{FR} is omitted.

It shows with respect to the measurement of the wheel speeds v_{FL}, v_{FR}, v_{RL} and v_{RR} that the reference speed v_{REF}, whose value is produced from the measuring signals of four wheel seed sensors, can be determined very precisely in almost all driving situations and is virtually unaffected by disturbing effects. In contrast to this, the determination of the speed difference v_{RR}−v_{RL} contained in the substitute signal \dot{ψ}_{EST} is based on the precise knowledge of the wheel speeds v_{RR} and v_{RL} of the rear wheels. This difference must hence be assessed as interference-prone.

To form models which shall be independent of any one of the possibly faulty measuring signals, the reference speed v_{REF} and the difference v_{RR}−v_{RL} are therefore dealt with like independent process variables, and the reference speed v_{REF} can be included in each of the models.

The abbreviation Δv_{R}=v_{RR}−v_{RL} is introduced at this point for the speed difference v_{RR}−v_{RL}.

A process that shall be controlled by the driving dynamics control such as the yaw rate variation for the vehicle can be reproduced in models being constructed with the steering angle δ, the lateral acceleration a_{LAT}, the vehicle reference speed v_{REF} and the rear-wheel speeds v_{RL} and v_{RR} or the difference Δv_{R}. Variables f whose values are not accessible for a direct measurement can consequently be obtained in a maximum model, that means a model with the maximum number of variables contained, with f=f(δ, a_{LAT}, Δv_{R}), wherein the dependency on the reference speed v_{REF} and the dependency on the vehicle parameters p are not illustrated explicitly herein.

First of all, it becomes conspicuous that likewise the substitute signal \dot{ψ}_{EST} is not produced in the maximum model because it is calculated independently of the steering angle δ. However, it has shown empirically that this reproduction of the yaw rate signal \dot{ψ} provides a very reliable value for the yaw rate \dot{ψ} in the majority of driving situations.

In addition, the ESP control is principally performed in such a fashion that values for the actuation parameters are determined depending on the control deviation between the substitute signal \dot{ψ}_{EST} and a nominal value for the yaw rate. In this arrangement, the nominal values are obtained from a vehicle reference model based on the reference speed v_{REF} and the steering angle δ. Thus, the steering angle δ is also implicitly considered in the control by way of the substitute signal \dot{ψ}_{EST}.

Due to the fact that the nominal value is produced by way of the steering angle δ, it shall even be preferred to determine the actual value by way of a model which is independent of the steering angle δ.

It is now possible to form different partial models of the maximum model which are formed with different quantities of process variables, respectively forming a subset of the multitude of all measured process variables. Each one of these auxiliary models is thus independent of measured values of at least one of the sensors of the sensor cluster and, thus, also insusceptible to malfunctions of the corresponding sensor.

Corresponding to the previous argumentation concerning the signals of the wheel speeds v_{FL}, v_{FR}, v_{RL} and v_{RR}, the auxiliary models in the embodiment under review are produced with multitudes of variables which are (real) subsets of the quantity {δ, a_{LAT}, Δv_{R}}. In addition, the models can depend on the reference speed v_{REF}.

In model 1, the control variable, that means in this case the yaw rate \dot{ψ}, is illustrated by a correlation of the form
f₁=f₁(δ,a_{LAT}).
Hence, the model 1 manages without the signal representative of the value of the speed difference Δv_{R}.

In model 2 a relation of the form
f₂=f₂(a_{LAT},Δv_{R})
is applicable for a control variable so that this model is independent of the measuring signal of the steering angle sensor.

And finally the measuring signal for the lateral acceleration a_{LAT} is excluded in the model 3. This means that
f₃=f₃(δ, Δv_{R})
applies for the control variable established in this model. It is now investigated separately for the models whether there is a need for control for the overall system within the models.

In the case of model 1 this investigation can be carried out e.g. by comparing the stationary yaw rates \dot{ψ}_{δ} and \dot{ψ}ₐ_{_{LAT}}. calculated from steering angle δ and lateral acceleration a_{LAT}. This means that deviations are determined between the signal

$${\dot{ψ}}_{δ} = \frac{δ \cdot {v}_{REF}}{1 + eg \cdot {v}_{REF}^{2}}$$

for the yaw rate \dot{ψ}_{δ}, where l designates the wheel base of the vehicle and e.g. designates its self-steering gradient, and the signal

$${\dot{ψ}}_{{a}_{LAT}} = \frac{{a}_{LAT}}{{v}_{REF}}$$

for the yaw rate \dot{ψ}ₐ_{_{LAT}}, which indicate a need for control when a certain threshold value is exceeded. It would, however, also be possible in model 1 to compare the value of \dot{ψ}ₐ_{_{LAT}} with the nominal value for the yaw rate \dot{ψ} determined by the ESP control by way of the steering angle δ in order to identify a need for control. A comparison of the value of \dot{ψ}_{δ} with the nominal value is generally not preferred, however, because in this case both the nominal value and the actual value of the control variable being the basis of a possible need for control depend on the measuring signal of the steering angle δ. In certain driving situations, however, this comparison may also be performed. Besides, several or all of the described comparisons may be provided for securing the need for control for model 1.

For model 2 the sideslip angle β of the vehicle can be assessed based on the lateral acceleration a_{LAT} and the wheel speed difference Δv_{R} by way of the form

$$β = \int [ {\dot{ψ}}_{EST} - \frac{{a}_{LAT}}{{v}_{REF}} ] ⅆ t .$$

The so determined value for the sideslip angle β, which does not depend on the steering angle δ, may then be used to find out a need for control. This corresponds to the comparison of the signal \dot{ψ}ₐ_{_{LAT}} determined already for the model 1 with the substitute signal \dot{ψ}_{EST} in order to find out the need for control.

To check the need for control for the model 3, yaw rate signals can be compared which are produced from the wheel speed difference Δv_{R} and the steering angle δ. Thus, a comparison of the signal

$${\dot{ψ}}_{Δ {v}_{R}} = {c}_{1} \cdot Δ {v}_{R} - {c}_{2} \frac{δ \cdot {v}_{REF}^{3}}{1 + eg \cdot {v}_{REF}^{2}}$$

with the signal \dot{ψ}_{δ} may be performed in order to find out a need for control in case there is a deviation between the two signals that exceeds a certain threshold value. Similar to model 1, it is likewise possible to compare either the signal \dot{ψ}_{Δv}_{_{R}} or the signal \dot{ψ}_{δ} or both signals with the nominal value for the yaw rate \dot{ψ} determined by way of the ESP control.

The phase variation of all auxiliary models should be adapted to the requirements of the overall system by an appropriate signal processing operation, in particular an appropriate filtering operation.

In addition, an evaluation of the need for control in the individual partial models should be supplemented by situation detection. The quality of the individual models in a defined situation can be detected in a way as has been explained already hereinabove by way of the example of at least qualitatively recordable disturbances such as a roadway inclination or a brake intervention. Further, a vehicle reference model is implemented into the control system and allows the situation detection system to find out which models describe the vehicle performance in a situation with a sufficient rate of accuracy.

The control logic of the illustrated yaw rate control without a yaw rate sensor must now be slightly extended compared to the standard control logic of the control system including a yaw rate sensor.

Initially it is found out by the standard control logic whether the entry conditions for a control intervention are fulfilled due to a control deviation between the substitute yaw rate signal \dot{ψ}_{EST} and the nominal value of the yaw rate \dot{ψ}.

All auxiliary models are, however, evaluated prior to the commencement of the control intervention, as has been described hereinabove. It will be decided only after this evaluation whether an unlimited control intervention, a limited control intervention or, possibly, no control intervention at all will be performed.

An unlimited control operation is only permitted when there is a need for control both due to the value of the substitute signal \dot{ψ}_{EST} and in all auxiliary models. The control intervention is executed in this case, in particular as regards its duration and intensity, like in the case of conventional driving dynamics control with a yaw rate sensor.

If need for control does not prevail in all auxiliary models, this fact leads to assume that one of the input signals is disturbed and that possibly there is in fact no situation that requires a control intervention. Due to the limited information based on which the yaw rate signal is produced within the process models, it is, however, also possible that in fact there is no signal fault and, hence, there is need for control.

Therefore, a control intervention is performed even if there is a need for control not for all the models, yet for the majority of the models. In this case, however, a limited control intervention is performed in order to reduce the effects of an erroneous control intervention for which there is a certain, finite probability in this case.

As this occurs, the control intervention is limited in its duration and/or in its intensity depending on the models indicative of a need for control.

When e.g. model 1 as the only model does not show a need for control, only pressure requests up to a maximum of 15 bar for the brake pressure are admitted. When, on the other hand, model 2 is the only model for which no need for control exists, the control logic will allow only control interventions of a maximum duration of 300 ms.

When, finally, a need for control exists only for a small number of models, it is very likely that a measuring signal is disturbed. A control intervention will be totally suppressed in this case.

The disclosed principle of the combined consideration of standard logic and auxiliary models is illustrated in the only FIGURE by way of sectional areas of four circles. Circle 10 represents the standard logic of the ESP system on the basis of the substitute signal \dot{ψ}_{EST}, wherein a need for control for the ESP system exists for the conditions of the system being represented by points within the circle 10.

In a similar fashion, the circle areas 20, 30 and 40 represent a need for control for the models 1, 2 and 3.

The different coloring of various segments illustrates in the FIGURE under which conditions a control intervention is performed. The light grey sections represent limited control interventions and the dark grey section represents unlimited control interventions.

Based on this logic, the invention renders it possible to avoid erroneous control interventions and identify and perform necessary control interventions with a high degree of reliability. In particular the ability to perform limited control interventions proves to be a favorable compromise which takes into consideration the probability distribution of the occurrence of disturbed measuring signals.

This condition is also supported by the observation that control cycles with limited control interventions frequently appear directly before or after an unlimited control because a need for control is detected too late and/or is reset too early in some process models. In general, this does not lead to a significant reduction of the control quality so that the functionality of a control system is maintained in almost the same standard compared to the functionality of a control system will a complete sensor system.

The disclosed control logic achieves an inappropriate control only if due to a signal fault no need for control has been detected for the overall system, however, in fact there is a need for control.

In this case, the models can be evaluated, however, by way of situation detection in order to determine which of the measuring signals is disturbed. It has been illustrated in this respect in the above-mentioned example that a disturbance of the wheel speeds v_{FL}, v_{FR}, v_{RL} and v_{RR} is detected by way of a brake intervention.

A change-over for a limited time to a substitute signal, as described above, is then possible in the event of trouble in the wheel speed sensors, e.g. a change-over to the signal \dot{ψ}_{EST,TEMP}.

This mode, in which a change-over between several substitute signals is possible, in particular allows not having to instantaneously stop an already active control cycle when trouble occurs. However, as it is no longer possible to protect the signals after a change-over to a different signal, it is suitable to limit the extent and duration of the control request.

Thus, the invention provides a favorable method of controlling a process which permits producing a substitute signal for an omitted or failed sensor signal, which substitute signal is introduced into the existing standard control logic. To the extent possible, recordable faults of the substitute signal are compensated or eliminated; alternatively, a momentary change-over to another temporary substitute signal is carried out.

Beside the first process model in which the substitute signal is produced, additional process models are constructed for which a need for control is individually checked. After evaluation of these models a decision is taken whether control requests are realized in an unlimited manner, or whether intensity and/or duration of the interventions are limited, or whether a control intervention is totally suppressed. Thus, erroneous control interventions due to non-recordable faults are effectively prevented, or limited in their effect, respectively.

### List of Reference Numerals

a_{LAT} lateral acceleration
β sideslip angle
c₁ vehicle parameter
c₂ vehicle parameter
δ steering angle
eg self-steering gradient
f₁ substitute signal for the control variable signal in model 1
f₂ substitute signal for the control variable signal in model 2
f₃ substitute signal for the control variable signal in model 3
l wheel base
p vehicle parameter
\dot{ψ} yaw rate or yaw rate signal
\dot{ψ}_{EST} substitute signal for the yaw rate signal
\dot{ψ}_{EST,TEMP} temporary substitute signal for the yaw rate signal
\dot{ψ}_{δ} yaw rate determined by way of the steering angle
\dot{ψ}ₐ_{_{LAT}} yaw rate determined by way of the lateral acceleration
Δ\dot{ψ}_{EST} difference between yaw rate signals
v_{FL} wheel speed of the left front wheel
v_{FR} wheel speed of the right front wheel
v_{RL} wheel speed of the left rear wheel
v_{RR} wheel speed of the right rear wheel
v_{REF} reference speed
Δv_{R} difference v_{RR}−v_{RL}
10 circle, the area of which represents the need for control due to the substitute signal for the control variable signal
20 circle area representing the need for control for the model 1
30 circle area representing the need for control for the model 2
40 circle area representing the need for control for the model 3

1-11. (canceled)

12. A method for controlling a process comprising:
determining a control deviation by comparing a nominal value with an actual value of a control variable;
determining a need for control based on the determined control deviation;
determining an actual value of the control variable by way of a first process model; and
verifying the need for control by determining control requirements based on values of the control variable, wherein the control requirements are defined by way of additional process models and linked to each other by logical operations.

13. The method according to claim 12, wherein the additional process models are produced with various subsets of a multitude of measured variables.

14. The method according to claim 12, wherein a need for control (20) is found out only when there is a need for control (20, 30, 40) for the majority of the additional process models.

15. The method according to claim 12, wherein an unlimited control intervention due to the control deviation between the nominal value and the actual value is determined by way of the first process model is performed only when there is a need for control for all additional process models.

16. The method according to claim 12, wherein a control intervention with a reduced duration is performed unless a need for control exists for all additional process models.

17. The method according to claim 12, wherein a control intervention with a reduced intensity is performed when there is a need for control for all of the additional process models.

18. The method according to claim 12, wherein a control intervention is completely suppressed when there is no need for control for any one of the additional process models.

19. The method according to claim 12, wherein a value of an actuation parameter is modified depending on at least one value of the control variable determined by way of the additional process models.

20. The method according to claim 12, wherein the process concerns a yaw rate variation in a vehicle.

21. The method according to claim 12, wherein the control variable concerns a yaw rate of the vehicle.

22. The method according to claim 12, wherein a driving situation is determined where control of the driving stability is effected based on the logical operation of the values of the control variable determined by way of the partial models or based on the logical operation of the control variable values with predetermined limit values.
